(19) United States
(12) Patent Application Publication
(10) Pub. No.: US 2017/0222361 A1
(43) Pub. Date: Aug. 3, 2017

(54) ELECTRICAL CONNECTION SYSTEM

(71) Applicant: FORD GLOBAL TECHNOLOGIES, LLC, Dearborn, MI (US)

(72) Inventors: Jeremy Walter CHURCH, Belleville, MI (US); Gregory LEECE, Belleville, MI (US)

(21) Appl. No.: 15/012,218

(22) Filed: Feb. 1, 2016

(51) Int. Cl. H01R 13/627

(52) U.S. Cl. CPC H01R 13/6272

(57) ABSTRACT

An electrical connection system includes a male connector and a female connector. The male connector has a longitudinal extension. The female connector defines a socket that is configured to receive the male connector. The female connector also includes a stop and a biasing element. The biasing element has a first tapered protrusion. The first tapered protrusion is configured to engage the male connector such that the biasing element forces the longitudinal extension into contact with the stop.

### TECHNICAL FIELD

The present disclosure relates to electrical connection systems.

### BACKGROUND

Electrical connector technology may include an outer shell that engages an inner shell that provides alignment for the electrical terminals between the outer shell and the inner shell. Locking mechanisms may also be providing to provide positive retention between the inner shell and the outer shell in order to prevent disengagement of the inner and outer shells. Movement of the inner and outer shells relative to each other while they are engaged may result in wear. The wear in turn could lead to loss of the electrical connection. Methods of addressing this relative motion include the addition of sealing features. Tighter fitting seals may reduce the relative motion of the inner and outer shells of electrical connectors. However, tighter fitting seals may increase the insertion forces required beyond desirable limits making it difficult for a user to engage or disengage the inner and outer shells of the electrical connector.

### SUMMARY

An electrical connection system includes a male connector and a female connector. The male connector has a longitudinal or elongate extension. The female connector defines a socket that is configured to receive the male connector. The female connector also includes a stop and a biasing element. The biasing element has a first tapered protrusion. The first tapered protrusion is configured to engage the male connector such that the biasing element forces the longitudinal extension into contact with the stop.

A female electrical connector includes a housing, a stop and a biasing element. The housing defines a socket that is configured to receive a male connector. The stop is configured to limit the movement of the male connector in a direction of engagement between the male and female connectors. The biasing element has a first tapered protrusion. The first tapered protrusion is configured to engage the male connector such that the biasing element forces the male connector into contact with the stop.

An electrical connection system includes a female connector and a male connector. The female connector defines a socket that is configured to receive a male connector. The female connector has a biasing element that includes a protrusion that is tapered downward along a closed loop. The protrusion is configured to engage an internally extending tapered orifice that is defined by the male connector in order to prevent movement of the male connector relative to the female connector.

### BRIEF DESCRIPTION OF THE DRAWINGS

FIG. 1 is an illustration of a first embodiment of an electrical connection system having male and female connectors;

FIG. 2 is a cross-sectional view of the electrical connection system taken along line 2-2 in FIG. 1 showing the male and female connectors in an engaged position;

FIG. 3 is a cross-sectional view of a second embodiment of the electrical connection system;

FIG. 4A is an illustration of a third embodiment of the electrical connection system; and

FIG. 4B is an enlarged view of the area encompassed by circle 4B shown in FIG. 4A.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

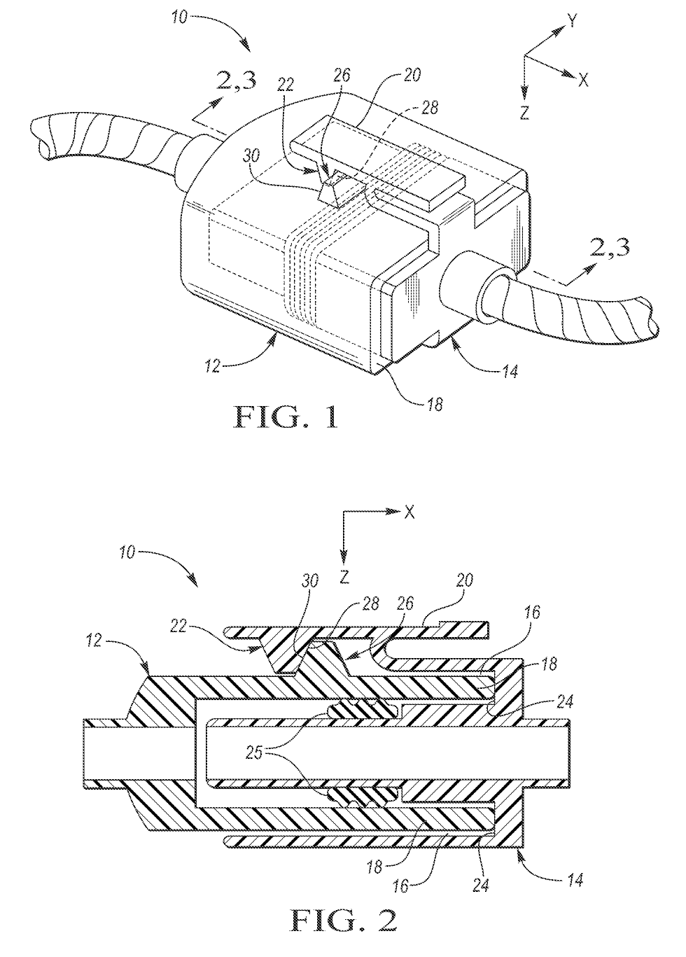

Referring to FIGS. 1 and 2, a first embodiment of an electrical connection system 10 having a male connector 12 and female connector 14 is illustrated. The male connector 12 and female connector 14 may consist of housings that are made from an insulating material such as, but not limited to, a plastic material. The male connector 12 and female connector 14 each carry mating electrical terminals that come into contact with each other in order create an electrical connection when the male connector 12 and female connector 14 are engaged. The female connector 14 is shown as disengaged from the male connector 12 in solid lines and engaged with the male connector 12 in phantom lines in FIG. 1.

The female connector 14 defines a socket (orifice) 16 that is configured to receive the male connector 12. The male connector 12 includes a longitudinal extension 18 that extends in the direction of engagement between the male connector 12 and female connector 14. The direction of engagement is indicated by the arrow extending in the X direction. The female connector 14 includes a biasing element 20. The biasing element may a portion of the housing of the female connector 14 or may be a separate spring. The biasing element 20 may have a preloaded force that acts in a downward direction as indicated by the arrow extending in the Z direction. A first tapered protrusion 22 may extend from the biasing element 20. The first tapered protrusion 22 may be configured to engage the male connector 12 such that the biasing element 20 forces the longitudinal extension 18 into contact with a stop 24 located on the female connector 14. The stop 24 may consist of a surface or wall located at the end of the socket 16. The stop 24 is configured to limit or eliminate movement of the male connector 12 relative to the female connector 14 when the longitudinal extension 18 is in contact with the stop 24 in order to prevent wear and tear of the respective parts of the electrical connection system 10. More specifically, the stop 24 is configured to limit or eliminate movement the male connector 12 relative to the female connector 14 in the direction of engagement between the male connector 12 and female connector 14. The female connector 14 may also include sealing elements 25 that also limit or eliminate movement the male connector 12 relative to the female connector 14.

The male connector 12 may include a second tapered protrusion 26 that is configured to engage the first tapered protrusion 22. The first tapered protrusion 22 may include a first surface 28 that engages the male connector 12 and tapers away from the stop 24 at an angle of greater than 90 degrees. The second tapered protrusion 26 may include a second surface 30 that engages the first tapered protrusion 22 and tapers toward the stop 24 at an angle of less than 90 degrees. More specifically the first surface 28 of the first tapered protrusion 22 may engage the second surface 30 of the second tapered protrusion 26. The downward force generated by the biasing element 20 is translated into a force in the direction of engagement (X direction) between the male connector 12 and female connector 14 when the first tapered protrusion 22 engages the male connector 12 (or more specifically the second tapered protrusion 26 of the male connector 12). Translating the downward force generated by the biasing element 20 into a force in the direction of engagement between the male connector 12 and female connector 14 ensures that the longitudinal extension 18 remains in contact with the stop 24 preventing relative movement of the male connector 12 and female connector 14, which in turn prevents wear and tear of the respective parts of the electrical connection system 10.

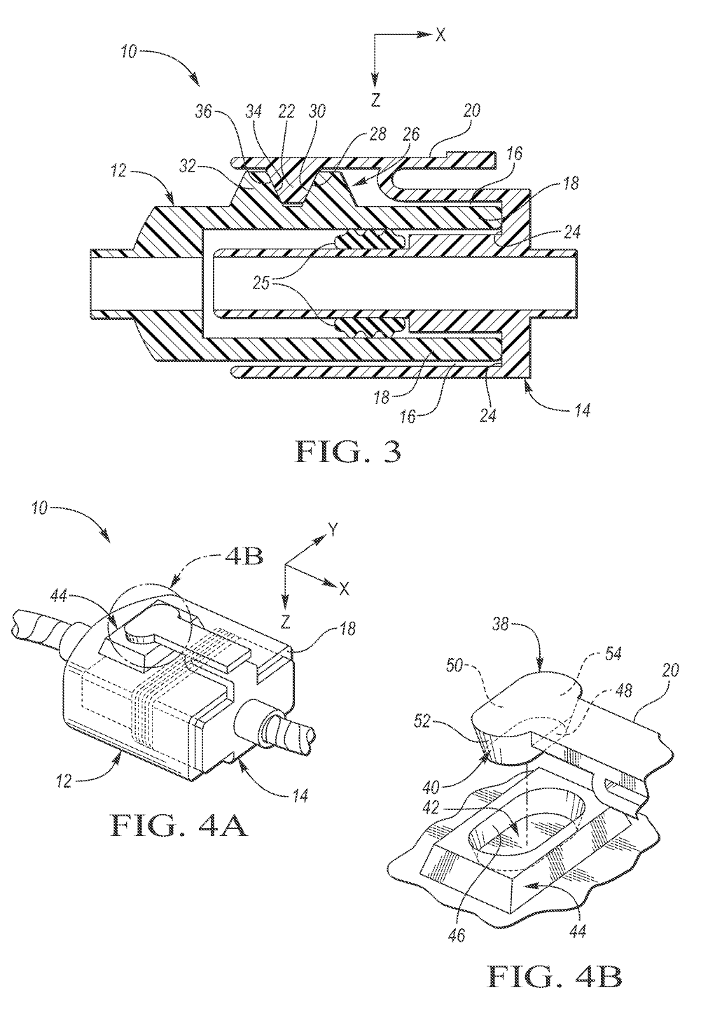

Referring to FIG. 3, a second embodiment of the electrical connection system 10 illustrated. The second embodiment includes all of the elements of the first embodiment that are numbered from 12 to 30. The elements that are included in the second embodiment that are also included in the first embodiment are structurally and functionally the same unless otherwise indicated.

The second embodiment additionally includes a third tapered protrusion 32 that extends from the male connector 12. The third tapered protrusion 32 may include a third surface 34 that may engage the female connector 14 and taper away from the stop 24 at an angle of greater than 90 degrees. More specifically the third surface 34 located on the third tapered protrusion 32 may engage a fourth surface 36 located on the first tapered protrusion 22. The fourth surface 36 located on the first tapered protrusion 22 tapers toward the stop 24 at an angle of less than 90 degrees.

Referring to FIGS. 4A and 4B, a third embodiment of the electrical connection system 10 illustrated. The third embodiment includes all of the elements of the first embodiment that are numbered 12, 14, 16, 18, 20, 24, and 25. The elements that are included in the third embodiment that are also included in the first embodiment are structurally and functionally the same unless otherwise indicated.

The female connector 14 of the third embodiment of the electrical connection system 10 includes a protrusion 38 that is tapered downward along a surface 40 defining a first closed loop. The protrusion 38 is configured to engage in internally extending tapered orifice 42 that is defined by a protrusion 44 that extends upward from the male connector 12 in order prevent movement of the male connector 12 and the female connector 14 relative to each other. The internally extending tapered orifice 42 may be tapered along a surface 46 defining a second closed loop. Engagement of the protrusion 38 with the internally extending tapered orifice 42 may comprise the surface 40 defining the first closed loop engaging the orifice along the surface 46 defining a second closed loop.

A first portion of the protrusion 38 consisting of a first side 48 of the surface 40 defining the first closed loop tapers away from stop 24 (the same way as shown in FIGS. 2 and 3) at an angle of greater than 90 degrees. A second portion of the protrusion 38 consisting of a second side 50 of the surface 40 defining the first closed loop tapers towards the stop 24 at an angle of less than 90 degrees. A third portion and a fourth portion of the protrusion consisting of a third side 52 and a fourth side 54, respectively, of the surface 40 defining the first closed loop each taper downwards at angles that are substantially 90 degrees relative to the angle of the downward taper of the first side 48 and second side 50 along the XY plane. Substantially 90 degrees may include 90 degrees plus or minus 10 degrees. When the protrusion 38 is engaged with the internally extending tapered orifice 42 relative movement of the male connector 12 and female connector 14 in two directions (X and Y or along the XY plane) may be limited or eliminated.

Alternatively, the female connector 14 may include at least two protrusions the taper downward along at least two angles that engage two protrusions located on the male connector 12 the taper upwards along at least two opposing angles in order to prevent movement of the male connector 12 and female connector 14 in two directions (X and Y or along the XY plane). In this alternative embodiment, the angle of the tapers on the two protrusion of the female connector 14 may extend downward at angles that are substantially 90 degrees relative to each other along the XY plane, while the angle of the tapers and protrusions of the male connector 12 may extend upward at angles that are substantially 90 degrees relative to each other along the XY plane.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

1. An electrical connection system comprising:
a male connector having a longitudinal extension; and
a female connector defining a socket configured to receive the male connector, the female connector including a stop and a biasing element having a first tapered protrusion configured to engage the male connector such that the biasing element forces the longitudinal extension into contact with the stop.

2. The system of claim 1, wherein the first tapered protrusion includes a surface that engages the male connector and tapers away from the stop at an angle of greater than 90 degrees.

3. The system of claim 1, wherein the male connector includes a second tapered protrusion configured to engage the first tapered protrusion.

4. The system of claim 3, wherein the second tapered protrusion includes a surface that engages the first tapered protrusion and tapers toward the stop at angle of less than 90 degrees.

5. The system of claim 3, wherein the first tapered protrusion tapers downward along at least two angles and the second tapered protrusion tapers upward along at least two opposing angles relative to the at least two angles such that engagement of the first tapered protrusion and the second tapered protrusion prevents movement of the male and female connectors relative to each other in at least two directions.

6. The system of claim 5, wherein a first angle and a second angle of the at least two angles extend downward in directions that are substantially 90 degrees relative to each other.

7. The system of claim 1, wherein the stop is a surface located at an end of the socket.

8. A female electrical connector comprising:
a housing defining a socket configured to receive a male connector;
a stop configured to limit the movement of the male connector in a direction of engagement between the male and female connectors;
a biasing element having a first tapered protrusion, wherein the first tapered protrusion is configured to engage the male connector such that the biasing element forces the male connector into contact with the stop.

9. The electrical connector of claim 8, wherein the first tapered protrusion includes a surface that engages the male connector and tapers away from the stop at an angle of greater than 90 degrees.

10. The electrical connector of claim 8, wherein the first tapered protrusion is configured to engage a second tapered protrusion located the male connector.

11. The electrical connector of claim 10, wherein the second tapered protrusion includes a surface that engages the first tapered protrusion and tapers toward the stop at angle of less than 90 degrees.

12. The electrical connector of claim 10, wherein the first tapered protrusion tapers downward along at least two angles and the second tapered protrusion tapers upward along at least two opposing angles relative to the at least two angles such that engagement of the first tapered protrusion and the second tapered protrusion prevents movement of the male and female connectors relative to each other in at least two directions.

13. The electrical connector of claim 12, wherein a first angle and a second angle of the at least two angles extend downward in directions that are substantially 90 degrees relative to each other.

14. The electrical connector of claim 8, wherein the stop is a surface located at an end of the socket.

15. An electrical connection system comprising:
a female connector defining a socket configured to receive a male connector, the female connector having a biasing element that includes a protrusion that is tapered downward along a closed loop and is configured to engage an internally extending tapered orifice that is defined by the male connector to prevent movement of the male connector relative to the female connector.

16. The electrical connection system of claim 15, wherein the female connector further comprises a stop.

17. The electrical connection system of claim 16, wherein the male connector further comprises an elongate extension.

18. The electrical connection system of claim 17, wherein the protrusion engages the tapered orifice such that the biasing element forces the elongate extension into contact with the stop.

19. The electrical connection system of claim 18, wherein a portion of the protrusion that extends along the closed loop that engages the tapered orifice tapers away from the stop at an angle of greater than 90 degrees.

20. The electrical connection system of claim 19, the stop is a surface located at an end of the socket.
